(19) United States
(12) Patent Application Publication
(10) Pub. No.: US 2005/0107205 A1
(43) Pub. Date: May 19, 2005

(54) Bearing and stepless transmission having a bearing

(76) Inventors: Armin Veil, Murrhardt (DE); Ernst Walth, Nordheim (DE)

Correspondence Address: WILLIAM COLLARD;COLLARD & ROE, P.C., 1077 NORTHERN BOULEVARD, ROSLYN, NY, 11576, US

(21) Appl. No.: 10/987,962

(22) Filed: Nov. 12, 2004

(30) Foreign Application Priority Data
Nov. 14, 2003 (DE) 103 53 130.0

(51) Int. Cl. F16H 37/02

(52) U.S. Cl. 475/210; 384/593

(57) ABSTRACT

An axial bearing in a transmission and a transmission having transmission elements adjacent to an axial bearing, particularly a stepless transmission, are provided. The axial bearing has a running surface or the orientation thereof predetermined directly by a shaft nut, in contrast with prior axial bearings, in which run-up disks form an additional component that must be precisely aligned with regard to adjacent components, so that parallel running surfaces result for the axial bearing.

### CROSS REFERENCE TO RELATED APPLICATIONS

Applicants claim priority under 35 U.S.C. §119 of German Application No. 103 53 130.0 filed Nov. 14, 2003.

### BACKGROUND OF THE INVENTION

1. Field of the Invention

The present invention relates to a bearing having a first transmission element and a second transmission element, which are mounted to rotate about an axis relative to one another, and which are supported against one another in the direction of the axis, by way of an axial bearing, wherein the first transmission element has a shaft nut, by means of which positional fixation of another transmission element disposed on the first transmission element takes place. Beyond that, the invention relates to the use of such bearings in stepless transmissions.

2. The Prior Art

In known bearings, a first transmission element as well as a second transmission element are mounted to rotate relative to one another about an axis. An axial support of the transmission elements in the direction of the aforementioned axis takes place by way of an axial bearing.

In order to guarantee the function of the axial bearing, it is necessary that precisely parallel running surfaces, oriented crosswise for support in the direction of the aforementioned axis, are present, which are assigned to the first transmission element, for one thing, and to the second transmission element, for another thing. If the orientation of the running surfaces does not lie within a narrow tolerance band, problems can occur. These problems include vibration excitation of the transmission elements, function impairment, increased wear, failure of the axial bearing, and/or a reduction of the useful lifetime of the axial bearing. In order to avoid these problems, it is known to provide the running surface on running bodies whose orientation is precisely predetermined, in each instance, by means of area contact of the running bodies on the transmission elements. The area contact can involve, for example, a fit of an inside diameter of the running body with an outside diameter of a shaft, an outside diameter of the running body and an inside diameter of an adjacent transmission element, or a contact surface oriented crosswise to the longitudinal axis of the running body on an adjacent transmission element.

### SUMMARY OF THE INVENTION

It is an object of the present invention to provide a bearing and a use of a bearing, which guarantees sufficient functioning of the axial bearing with low effort and expenditure for the component and/or for assembly, as well as for material use.

These and other objects are achieved by providing a bearing according to the inventions which makes use of a shaft nut by means of which positional fixation of another transmission element disposed on a transmission element, such as a gear wheel or a bearing body, takes place. According to the invention, a face of this shaft nut forms a running surface for roller bodies of the axial bearing.

The invention is therefore based on the recognition that the use of a special, i.e. additional running body for presenting the running surface for the roller bodies of the axial bearing is not absolutely necessary. Instead of such an additional running body, the shaft nut finds multifunctional use, since it serves, on the one hand, to form the running surface for the roller bodies of the axial bearing and, on the other hand, for fixing the position of the other transmission element. With this arrangement, the invention overcomes the prejudice of a person skilled in the art, that a precise predetermination of an orientation of a face of a shaft nut is allegedly not possible. This prejudice results from the belief that the predetermination of an exact positional angle of the shaft nut by way of the connection of the thread of the shaft nut with the corresponding thread of the first transmission element is not possible. By means of the multifunctional use of the shaft nut in accordance with the invention, the additional component of a running body is therefore not necessary. In this way, construction space and/or weight for the bearing can be saved.

In another aspect, a bearing is provided in which the roller bodies of the axial bearing roll on a run-up disk. An orientation of the run-up disk is exclusively predetermined by the shaft nut, in accordance with the invention. According to this aspect, a predetermination of the orientation of the running surface for the roller bodies takes place by way of the thread of the shaft nut. In this connection, the run-up disk can support itself particularly on an inside surface on a cylindrical mantle surface of the shaft nut and/or on a face of the shaft nut oriented crosswise to the longitudinal axis of the shaft nut. This aspect of the invention also makes use of the recognition that a precise predetermination of the position of a running surface is possible by way of the shaft nut.

Preferably, the run-up disk lies against an axial face of the shaft nut. A continuation of the shaft nut is passed through the run-up disk, lying radially on the inside. The continuation and/or other components connected with it, lying on the inside or in the partial region that projects out of the run-up disk, can fulfill additional functionalities. These functionalities include preventing rotation of the shaft nut, particularly with related wedging regions, or making available another bearing surface.

According to another embodiment of the bearing, the axial bearing has two run-up disks that enclose the roller bodies. In this case, the run-up disks are connected with one another by way of a cage. The axial bearing thereby forms a compact structural unit. For such a configuration, a non-precise and parallel orientation of the running surfaces leads to additional stress on the cage that connects the run-up disks, which, in the worst case, can result in mechanical failure of the cage. According to the invention, a predetermination of the orientation of the running surfaces also takes place by way of the shaft nut, in this case.

A use of one of the aforementioned bearings in a stepless transmission that has a variator equipped with a looping means is of particular advantage. In this case, the first transmission element is configured as a variator shaft. The variator shaft is connected to rotate with a disk of the variator. A second transmission element is fixed in place axially on the variator shaft, by means of a shaft nut. For example, the additional transmission element is a roller bearing, by means of which the variator shaft is supported relative to a transmission housing. An adjacent second transmission element is axially supported relative to the variator shaft by way of an axial bearing. In accordance with a first variant of the invention, the face of the shaft nut that lies opposite the additional transmission element, forms a running surface for roller bodies of the axial bearing. The additional transmission element may be, for example, the roller bearing. In accordance with a second variant of the invention, the face of the shaft nut that lies opposite the additional transmission element exclusively determines the orientation of a run-up disk on which roller bodies of the axial bearing roll.

The aforementioned advantages of the bearing according to the invention are adapted to be used in a stepless transmission having a variator. This use results in a particularly precise configuration of a stepless drive, particularly a particularly short variator shaft, and a particularly light configuration and/or one having few components.

Preferably, the second transmission element can be connected with a transmission brake, so that support of the variator shaft takes place relative to a second transmission element fixed in place in the housing, in the switching state in question.

In accordance with a further embodiment of the invention, the second transmission element connected with the transmission brake is configured for bearing at least one planet of a planetary gear set. The second transmission element thereby has a ridge for bearing the at least one planet. In this way, the bearing according to the invention can be integrated into the stepless transmission particularly well, taking over several functions.

According to another specific embodiment, the bearing is used in a stepless transmission. In this case, the first transmission element is designed as a variator setting shaft. A means or device that acts together with the adjustment of the variator is axially fixed in place on the variator setting shaft, by way of the shaft nut. The aforementioned means is, for example, a setting piston for which the shaft nut predetermines an end position, or a centrifugal oil hood, see in this regard the German patent application DE 199 20 063 A1. Since the aforementioned means has both a radial and an axial expanse, small inaccuracies in the predetermination of the orientation of the means result in magnified deviations of the end surfaces of the means. For the case of the setting piston, these deviations cause an insufficient sealing effect or an increased wear of the seals of the setting piston provided in the end regions to occur. In the worst case, jamming of the setting piston can occur. Comparable problems also result for the centrifugal oil hood. Even for such intensified conditions, the inventors have recognized that a predetermination of the orientation of the means can take place according to the invention, by way of the setting nut. In this case, as well, the recognition according to the invention results in a reduced expenditure and effort for components, a simplified assembly and/or a reduced expenditure of material, and less required installation space.

According to another embodiment, two bearings according to the invention are used in the stepless transmission. The first bearing is for bearing one transmission element relative to the variator shaft. The second bearing is for bearing another transmission element relative to the variator setting shaft.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 shows a detail of a first example of a bearing according to the invention,

FIG. 2 shows a detail of a second example of a bearing according to the invention,

FIG. 3 shows a detail of a third example of a bearing according to the invention,

FIG. 4 is a gear plan of a stepless transmission,

FIG. 5 shows a detail of a stepless transmission having a bearing according to an embodiment of the invention, and

FIG. 6 shows a detail of a stepless transmission having an alternative configuration of a bearing according to the invention.

### DETAILED DESCRIPTION OF PREFERRED EMBODIMENTS

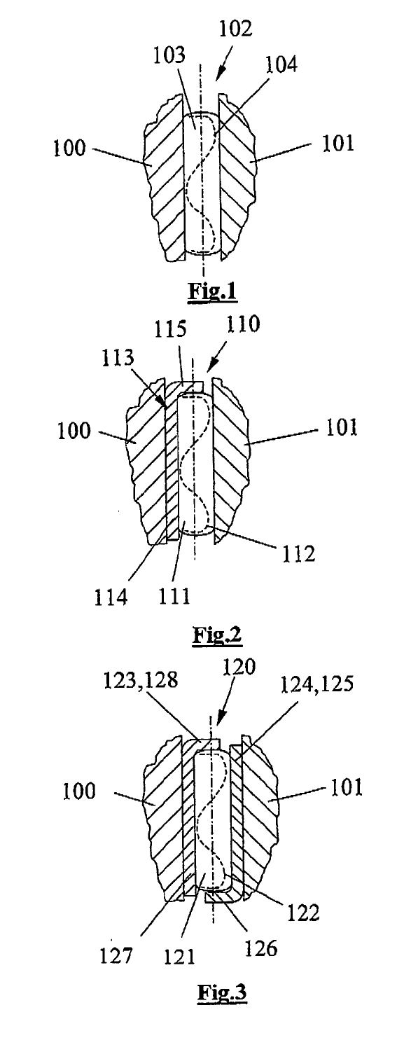

Turning now in detail to the drawings, FIGS. 1 to 3 show the fundamental structure of alternative configurations of an axial bearing. In this connection, the support between a first component 100 and a second component 101 takes place with the guarantee of a relative twist of the components 101 about an axis X-X as well as under axial support.

According to FIG. 1, an axial bearing 102 is disposed between faces of components 100, 101 that are oriented parallel and crosswise to axis X-X, which bearing has roller bodies 103 as well as a cage 104 that holds roller bodies 103.

An axial bearing 110 shown in FIG. 2 has roller bodies 111, a cage 112 that holds the roller bodies 111, and a run-up body 113. Run-up body 113 is designed to be L-shaped in cross-section. Run-up body 113 has a vertical run-up disk 114 and a horizontal part 115. Horizontal part 115 is disposed on the side of axial bearing 110 facing axis X-X or, instead, on the side facing away from axis X-X. While roller bodies 111 roll directly on the faces of second component 101, the roller bodies roll on run-up disk 114, which rests against the face of first component 100 over a large area or the entire area, on the opposite side.

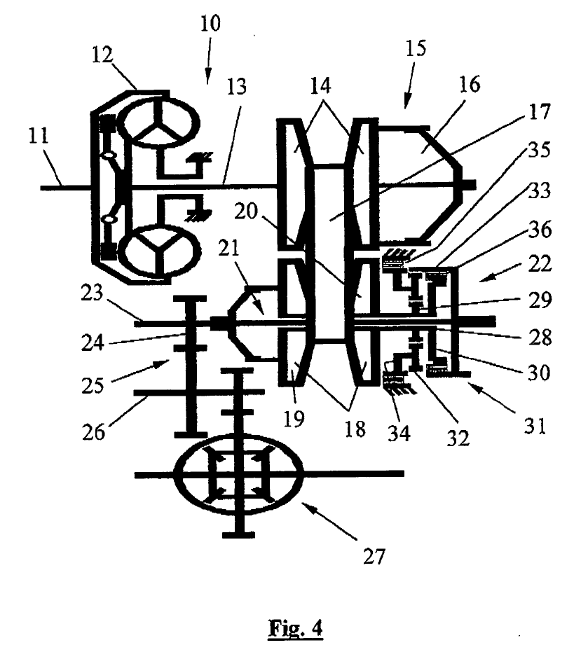

According to an exemplary embodiment shown in FIG. 3, an axial bearing 120 has roller bodies 121, a cage 122 holding the roller bodies, as well as run-up bodies 123, 124. Run-up body 123 is designed to correspond to run-up body 113 according to FIG. 5 and is disposed between the face of first component 100 and roller bodies 121. Run-up body 124 is designed to be L-shaped in cross-section. The vertical part of the L-shaped cross-section of run-up body 124 forms a run-up disk 125, which is oriented parallel to the run-up disk of run-up body 123. Run-up body 124 furthermore has a horizontal part 126, which is disposed on the side of roller bodies 121 that lies opposite the horizontal part of run-up body 123. First and/or second component 100, 101 is/are preferably a shaft nut according to the invention, a first transmission element and/or a second transmission element. The faces of components 100, 101, as shown, as well as of run-up bodies 113, 114 as well as 123, 124 are oriented approximately parallel to one another as well as crosswise to axis X-X.

The aforementioned axial bearings are preferably used in a transmission, preferably a stepless transmission 10 of a motor vehicle having front or rear wheel drive.

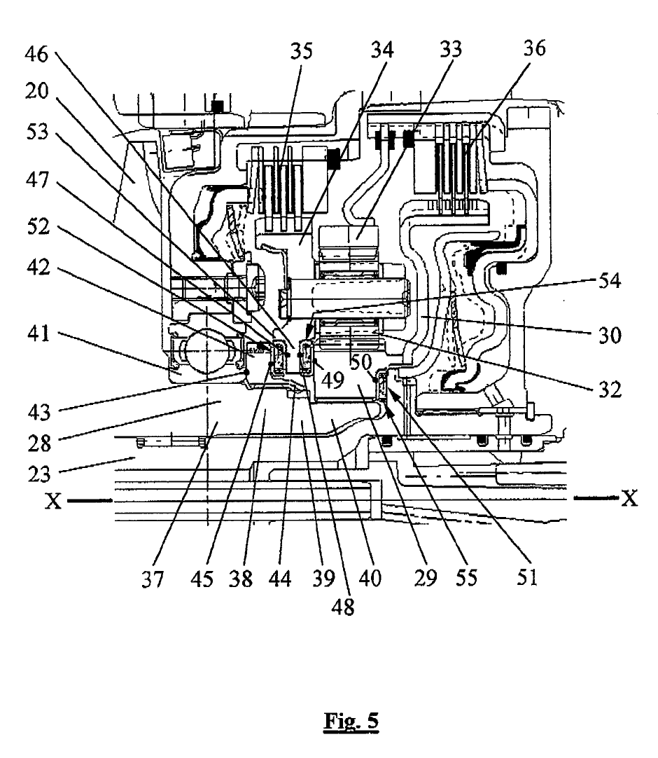

In the case of the stepless transmission 10 shown in FIG. 4, an engine shaft 11 is connected with a transmission input shaft 13 by way of a hydrodynamic torque converter 12. Hydrodynamic torque converter 12 has a converter bridging coupling and suitable vibration damping devices. Transmission input shaft 13 is connected with the drive disk set 14 of a variator 15, so as to rotate with it, which variator can be adjusted by means of a setting unit 16. Drive disk set 14 is in a drive connection with the power take-off disk set 18, which has a first disk 19 as well as a second disk 20, by way of a looping means 17. Power take-off disk set 18 has a setting unit 21 for stepless adjustment of the translation of variator 15 assigned to it.

Disk 20 is in a drive connection with a transmission shaft 23, by way of an intermediate transmission 22. Transmission shaft 23 passes axially through power take-off disk set 18. On the side of variator 15 that faces away from intermediate transmission 22, transmission shaft 23 bears a gear wheel 24. Gear wheel 24 is part of a transmission stage 25. By means of transmission stage 25, a transfer off the moment of transmission shaft 23 to an intermediate shaft 26, which in turn is in a drive connection with a distributor transmission 27, takes place.

Intermediate transmission 22 has a variator shaft 28 that is configured as a hollow shaft, through which transmission shaft 23 is passed and which is connected to rotate with disk 20, in an axial end region. In the opposite end region, variator shaft 28 bears a gear wheel 29 as well as a coupling disk 30, which are disposed closely adjacent to one another. Gear wheel 29 is part of a planetary gear set 31, which furthermore has planets 32 as well as a ring gear 33. Ring gear 33 is connected to rotate with transmission shaft 23. A ridge 34 of planets 32 can be connected with the transmission housing by way of a brake 35. Coupling disk 30 can be connected with ring gear 33, i.e. transmission shaft 23, by way of a coupling 36.

In accordance with the exemplary embodiment shown in FIG. 5, disk 20 is configured in one piece with the variator shaft 28. Variator shaft 28 has four partial regions 37 to 40, starting with disk 20, which regions are arranged in the aforementioned sequence, one behind the other. Each partial region 37, 38, 39, 40 has a narrowing in cross-section. The partial regions are connected with one another in each instance by way of a respective undercut.

Partial region 37 bears a roller bearing 41 on its cylindrical mantle surface.

Partial region 38 has an outside thread onto which the threaded nut 42 is screwed on. An inner ring of the roller bearing 41 is fixed or clamped in place axially between a facing face of disk 20 and a face 43 of shaft nut 42. Face 43 is disposed crosswise to the axis of rotation X-X of disk 20, variator shaft 28, and transmission shaft 23.

Partial region 39 has radial recesses taken out of the cylindrical mantle surface, in which tenon regions 44 that are formed by axial continuations of shaft nut 42 engage.

In the region of the mantle surface of partial region 40, a positive-lock connection of variator shaft 28 with gear wheel 29 is formed, for example by means of a dovetail gearing or a feather key. Gear wheel 29 is axially displaceable relative to partial region 40.

Shaft nut 42 has a face 45 on the side facing away from disk 20, which face is oriented parallel to face 43. Ridge 34 has a circular ring-shaped continuation 46 radially on the inside, which continuation is configured to be approximately U-shaped in the cross- section shown. The side shanks of U-shaped continuation 46 are formed by faces 47, 48. Gear wheel 29 has faces 49, 50. Transmission shaft 23 has a face 51. The faces 43, 45, 47, 48, 49, 50, 51 are oriented parallel to one another and crosswise to axis X-X.

An axial bearing 52 is disposed between faces 45, 47. Axial bearing 52 corresponds to the exemplary embodiment shown in FIG. 3, in a mirror-image installation position. In this embodiment, component 100 is formed by shaft nut 42 and component 101 is formed by ridge 34, i.e. by continuation 46. Axial bearing 52 has two run-up bodies 123, 124, between which roller bodies 121 disposed in a cage 122 are accommodated. Run-up body 124 facing shaft nut 42 is designed to be L-shaped in cross-section. The vertical part of the L-shaped cross-section forms a run-up disk 125, which rests against shaft nut 42 over a large part or its entire area in the region of the face 45, and on which the roller bodies 121 roll on the side facing away from shaft nut 42.

The radially inside end region of run-up disk 125 makes a transition into the horizontal partial region 126 of the L-shaped cross-section. Horizontal part 126 is oriented approximately parallel to axis X-X. A radial play is provided between run-up body 124 and shaft nut 42, so that run-up body 124 is in contact with shaft nut 42 merely in the region of run-up disk 125. The run-up disks 125, 127 are oriented crosswise to axis X-X. Run-up body 123 disposed on the side of axial bearing 52 facing away from shaft nut 42 also has an L-shaped cross-section. The horizontal part 128 of the L-shaped cross-section of run-up body 123 is disposed radially outside of the vertical part (run-up disk 127). Run-up disk 127 makes contact with face 47 of ridge 34, while horizontal part 128 finds (precisely fitted) accommodation in a collar 53 of ridge 34. Run-up bodies 123, 124 are connected with one another firmly, i.e. elastically, by way of a cage Preferably, horizontal parts 126, 128 of run-up bodies 123, 124 form radial guides for the roller bodies.

An axial bearing 54 is disposed between faces 48, 49, whereby axial bearing 54 is configured with mirror symmetry to a plane oriented crosswise to the axis X-x to axial bearing 52. Axial bearing 54 corresponds to the exemplary embodiment shown in FIG. 3, whereby component 100 is formed with ridge 34, i.e. continuation 46, and component 101 is formed with gear wheel 29. Axial bearings 52, 54 have essentially the same diameter. The outside diameter of axial bearings 52, 54 essentially corresponds to the outside diameter of shaft nut 42, i.e. of gear wheel 29.

An axial bearing 55 is disposed between faces 50, 51. Axial bearing 55 corresponds to the exemplary embodiment according to FIG. 2. In this embodiment, component 100 is formed with gear wheel 29 and component 101 is formed with face 51, i.e. with a related shoulder of transmission shaft 23. Axial bearing 55 merely has a run-up body 113, which is disposed between roller bodies 111 and gear wheel 29. On the side lying opposite run-up body 113, roller bodies 111 roll directly on face 51 of transmission shaft 23. By means of predetermining, i.e. setting the distance between faces 51 and 45, a bias of axial bearings 52, 54, 55 can be predetermined.

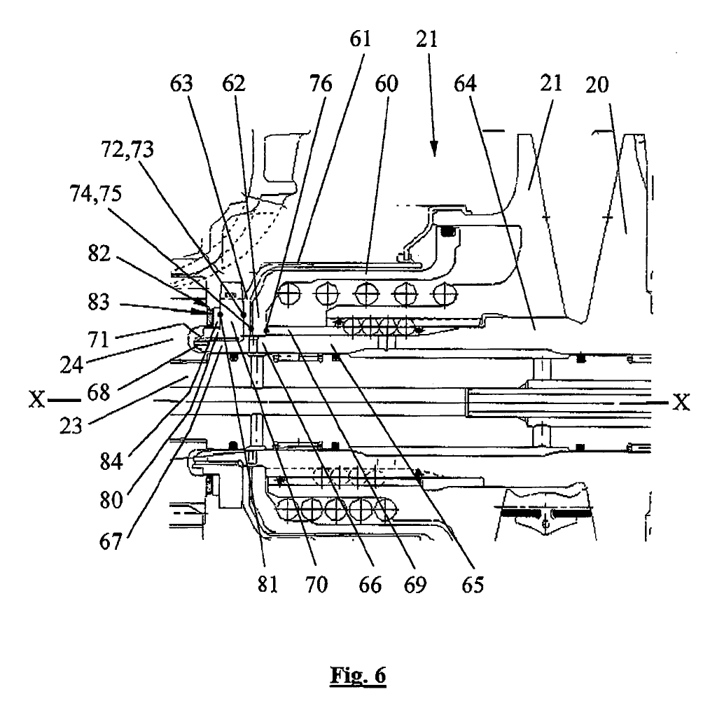

FIG. 6 shows a setting unit 21 that has a setting piston 60 as well as a centrifugal oil hood 61. With regard to the structure and function of the setting unit, as well as the components involved and their interaction, reference is made to the German patent DE 199 20 063 C1, with its entire scope. This patent shows a variator that has a rotary shaft and a piston-cylinder device which rotates with the shaft for setting the position of an axially adjustable cone disk of a cooperating cone disk pair for a transmission belt in a continuously variable transmission. The piston-cylinder device has at least one pressure chamber and at least one compensation chamber, for compensating the centrifugal force during the rotation of the piston-cylinder device, receiving the pressure medium via four radial channels.

As shown in FIG. 6, a setting piston 60 as well as a centrifugal oil hood 61 each have circular ring-shaped end regions 62, 63, which are oriented crosswise to axis X-X Disk 20 is connected to rotate with a variator setting shaft 64. In the exemplary embodiment shown in FIG. 3, variator setting shaft 64 and disk 20 are configured in one piece. In the end region of variator setting shaft 64 facing away from disk 20, the shaft has partial regions 65, 66, 67, and 68, in that sequence. Partial regions 65 to 68 follow one another with a reduction in cross-section, in each instance and, in particular, with the interposition of a respective undercut.

In the transition from partial region 65 to partial region 66, a shoulder 69 is formed. The face of end region 62 that faces away from a shaft nut 70 makes contact with shoulder 69 in a contact region oriented crosswise to axis X-X. Partial region 66 has a cylindrical mantle surface, which is surrounded by a cylindrical inside surface of end regions 62. 63. End regions 62, 63, on the one hand, and the cylindrical mantle surface of partial region 66, on the other hand, form a fit, particularly a transition or press fit, or a gap.

Partial region 67 has an outside thread onto which shaft nut 70 is screwed on. Partial region 68 possesses radial recesses out of a cylindrical mantle surface, into which tenon regions 71 that are formed by axial continuations of the shaft nut enter.

By tightening shaft nut 70 on variator setting shaft 64, the face 72 of shaft nut 70 and the face 73 of end region 63, the opposite face 74 of end region 63, and the facing face 75 of end region 62, as well as the opposite face 76 of end region 62, and shoulder 69, can be braced against one another. Faces 72, 73, 74, 75, 76 are oriented parallel to one another and essentially crosswise to axis X-X. The precise orientation of centrifugal oil hold 61 as well as of setting piston 60 is predetermined by means of the aforementioned faces.

Shaft nut 70 has an extension 80, in the form of a hollow cylinder, on the side facing away from setting unit 21, which is followed by tenon region 71. Extension 80 and tenon region 71 enter into a corresponding recess out of the gear wheel 24, at least in part. Extension 80 has a cylindrical mantle surface. An axial bearing 83 is disposed between a face 81 of the shaft nut that faces away from face 72 of shaft nut 70, and a face 82 of gear wheel 24. The roller bodies of the axial bearing 83 roll directly on face 82 of gear wheel 24. The roller bodies of axial bearing 83 are guided in a cage. On the side facing away from gear wheel 24, the roller bodies of axial bearing 83 roll on a circular ring-shaped run-up disk 84. Run-up disk 84 surrounds extension 80 of shaft nut 70, forming a fit or a connection with radial play, and lies against face 81 of shaft nut 70 on the side facing away from axial bearing 83.

Axial bearing 83 therefore corresponds to axial bearing 102 shown in FIG. 1, whereby component 100 is formed by gear wheel 24 and component 101 is formed by run-up disk 84.

The threads of shaft nut 70 and related partial region 67, as well as of shaft nut 42 and related partial region 38, are usual threads. In particular, a fine-pitch thread and/or a thread having elevated requirements with regard to the production tolerances may be used.

The axial bearings that are used are also referred to as multi-purpose bearings.

Shaft nuts 42, 70 as well as the related threads are produced from forged blanks with subsequent lathing work in this connection, the lathing contour has hardly any effect on the costs of the shaft nuts. Contact disks or surfaces can therefore be implemented in almost cost-neutral manner, by forming these disks or surfaces, according to the invention, directly or indirectly by the shaft nut. The invention goes against the prejudice of the art that a precise predetermination of the orientation of a shaft nut is not possible. If a bearing runs up on the shaft nut, large bearing diameters having a high support number and a long lifetime can be implemented. By running the axial bearing up on the nut, the bearing can be removed from the determining axial component chain of the shaft. This arrangement results in a clearly reduced transmission construction length.

Accordingly, although only a few embodiments of the present invention have been shown and described, it is to be understood that many changes and modifications may be made thereunto without departing from the spirit and scope of the invention as defined in the appended claims.

1. A bearing comprising:
(a) a first transmission element;
(b) a second transmission element; and
(c) an axial bearing comprising a plurality of roller bodies;
wherein said first and second transmission elements are mounted to rotate about an axis relative to one another and are supported against one another in the direction of the axis via said axial bearing;
wherein said first transmission element comprises a shaft nut for positionally fixing a third transmission element on said first transmission element; and
wherein said shaft nut comprises a shaft nut face forming a running surface for said roller bodies of said axial bearing.

2. A bearing comprising:
(a) a first transmission element;
(b) a second transmission element;
(c) an axial bearing comprising a plurality of roller bodies; and
(d) a run-up disk;
wherein said first and second transmission elements are mounted to rotate about an axis relative to one another and are supported against one another in the direction of the axis via said axial bearing;
wherein said first transmission element comprises a shaft nut for positionally fixing a third transmission element on said first transmission element; and
wherein said roller bodies of said axial bearing roll on said run-up disk, said run-up disk having an orientation exclusively predetermined by said shaft nut.

3. The bearing as recited in claim 2, wherein the run-up disk lies against an axial face of the shaft nut, said shaft nut comprising a continuation that passes through the run-up disk, lying radially on an inside portion of said run-up disk.

4. The bearing as recited in claim 2, wherein the axial bearing has two run-up disks that enclose the roller bodies, said disks being connected with one another via a cage.

5. A stepless transmission comprising;
(a) a bearing comprising a first transmission element, comprising a variator shaft, a second transmission element, an axial bearing comprising a plurality of roller bodies, and a run-up disk, said plurality of roller bodies rolling on said run-up disk, said first and second transmission elements being mounted to rotate about an axis relative to one another and supported against one another in the direction of the axis via said axial bearing, said first transmission element comprising a shaft nut or positionally fixing a third transmission element on said first transmission element, said shaft nut comprising a shaft nut face lying opposite the third transmission element and forming a running surface for said roller bodies of said axial bearing or exclusively determining the orientation of the run-up disk;
(b) a variator comprising a looping means and a variator disk;
wherein said variator disk is connected to rotate with said variator shaft;
wherein said third transmission element is secured axially on said variator shaft via said shaft nut; and
wherein said second transmission element is axially supported via said axial bearing.

6. The stepless transmission as recited in claim 5 wherein the third transmission element comprises a roller bearing.

7. The stepless transmission as recited in claim 5, wherein the second transmission element is adapted for connection to a transmission brake.

8. The stepless transmission as recited in claim 6, further comprising a planetary gear set having at least one planet mounted to rotate relative to the second transmission element.

9. A stepless transmission comprising:
(a) a variator comprising a looping means and a variator disk;
(b) a bearing comprising a first transmission element comprising a variator setting shaft, a second transmission element, an axial bearing comprising a plurality of roller bodies, and a run-up disk, said plurality of roller bodies rolling on said run-up disk, said first and second transmission elements being mounted to rotate about an axis relative to one another and supported against one another in the direction of the axis via said axial bearing, said first transmission element comprising a shaft nut for positionally fixing a third transmission element on said first transmission element, said shaft nut comprising a first shaft nut face facing away from said variator disk and a second shaft nut face facing said variator disk, said first nut face forming a running surface for said roller bodies of said axial bearing or exclusively determining the orientation of the run-up disk;
wherein said variator disk is connected to rotate with said variator setting shaft;
wherein said shaft nut fixes in place on said variator setting shaft a means that acts together with an adjustment of said variator, said means resting against said second shaft nut face; and
wherein said second transmission element is axially supported via said axial bearing.

10. The stepless transmission as recited in claim 9 wherein the means that acts together with an adjustment of the variator is selected from the group consisting of a setting piston and a centrifugal oil hood.

11. The stepless transmission as recited in claim 9, wherein the second transmission element is a spur wheel of a transmission stage.

12. The stepless transmission as recited in claim 11, wherein the spur wheel is connected to rotate with a transmission shaft, said transmission shaft passing axially through the variator and the variator setting shaft.

13. The stepless transmission as recited in claim 12, further comprising a planetary gear set adapted to connect with the variator shaft.
